(19) United States
(12) Patent Application Publication
(10) Pub. No.: US 2026/0247187 A1
(43) Pub. Date: Aug. 20, 2026

(54) COMMUNICATION METHOD, APPARATUS, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/992,694

(22) PCT Filed: Jul. 11, 2022
(86) PCT No.: PCT/CN2022/104956

§ 371 Date: Jan. 9, 2025

(51) Int. Cl. H04W 24/10

(52) U.S. Cl. CPC H04W 24/10

(57) ABSTRACT

A communication method is performed by a sensing responder, and includes sending a target radio frame. The target radio frame includes a Sensing Measurement Report information element, the Sensing Measurement Report information element includes a sensing measurement report control field, the sensing measurement report control field includes a subcarrier grouping subfield, and the grouping subfield indicates a number of subcarrier groups for channel sensing by a sensing initiator. A channel bandwidth of a Null Data Packet (NDP) is 160 MHz and a number of transmitting antennas of the sensing initiator is greater than or equal to 5, a value of the grouping subfield is 8.

### CROSS-REFERENCE TO RELATED APPLICATIONS

The present application is a U.S. National Stage of International Application No. PCT/CN2022/104956 filed on Jul. 11, 2022, the content of which is incorporated herein by reference in its entirety for all purposes.

### TECHNICAL FIELD

The embodiments of the present disclosure relate to the field of mobile communication technology. Specifically, the embodiments of the present disclosure relate to a communication method and apparatus, an electronic device, and a storage medium.

### BACKGROUND

With the rapid development of mobile communication technology, Wireless Fidelity (Wi-Fi) technology has made great progress in transmission rate and throughput. At present, the research content of Wi-Fi technology includes for example 320 Mhz bandwidth transmission, aggregation and coordination of multiple frequency bands, etc, and the main application scenarios thereof include for example video transmission, Augmented Reality (AR), Virtual Reality (VR), etc.

Specifically, the aggregation and coordination of multiple frequency bands refers to the communication between devices at 2.4 GHz, 5.8 GHz, 6 GHZ, and other frequency bands at the same time. For the scenario where devices communicate at multiple frequency bands at the same time, a new Media Access Control (MAC) mechanism needs to be defined for the purpose of management. In addition, the aggregation and coordination of multiple frequency bands is expected to support low-latency transmission.

At present, the maximum bandwidth supported by the aggregation and coordination technology of multiple frequency bands is 320 MHz (160 MHz+160 MHz). In addition, 240 MHz (160 MHz+80 MHz) and other bandwidths supported by existing standards may also be supported.

According to the Wi-Fi technologies currently under study, Wireless Local Area Network (WLAN) sensing technology may be supported. For example, application scenarios may be such as location discovery, proximity detection, and presence detection in dense environments (such as home environments and corporate environments). During the WLAN sensing measurement process, the sensing responder will send a sensing measurement report to the sensing initiator. Therefore, it is necessary to provide a format of a radio frame for sending the sensing measurement report so that it is suitable for meeting the WLAN sensing measurement requirements.

### SUMMARY

The embodiments of the present disclosure provide a communication method and an electronic device.

In an aspect, the embodiments of the present disclosure provide a communication method, which is performed by a sensing responder, and the method includes: sending a target radio frame.

The target radio frame includes a Sensing Measurement Report information element. The Sensing Measurement Report information element includes a sensing measurement report control field. The sensing measurement report control field includes a subcarrier grouping subfield. The grouping subfield indicates the number of subcarrier groups for channel sensing by a sensing initiator.

When the channel bandwidth of the Null Data Packet, NDP, is 160 MHz and the number of transmitting antennas of the sensing initiator is greater than or equal to 5, the value of the grouping subfield is 8.

In another aspect, the embodiments of the present disclosure further provide a communication method, which is performed by a sensing initiator, and the method includes: receiving a target radio frame.

The target radio frame includes a Sensing Measurement Report information element. The Sensing Measurement Report information element includes a sensing measurement report control field. The sensing measurement report control field includes a grouping subfield. The grouping subfield indicates the number of subcarrier groups for channel sensing by the sensing initiator.

When the channel bandwidth of the Null Data Packet, NDP, is 160 MHz and the number of transmitting antennas of the sensing initiator is greater than or equal to 5, the value of the grouping subfield is 8.

The embodiments of the present disclosure further provide an electronic device, including a memory, a processor, and a computer program stored on the memory and executable on the processor. When the processor executes the program, the method described in one or more of the embodiments of the present disclosure is implemented.

Additional aspects and advantages of the embodiments of the present disclosure will be partially given in the following description, which will become apparent from the following description or be understood through the practice of the present disclosure.

### BRIEF DESCRIPTION OF THE DRAWINGS

In order to more clearly illustrate the technical solutions in the embodiments of the present disclosure, the following will briefly introduce the drawings required for use in the description of the embodiments of the present disclosure. It shall be noted that the drawings described below are only some embodiments of the present disclosure. For those of ordinary skills in the art, other drawings can be obtained based on these drawings without creative labor.

FIG. 1 is one of the flow charts about the communication method provided by an embodiment of the present disclosure;

FIG. 2 is one of the schematic diagrams about the first example according to an embodiment of the present disclosure;

FIG. 3 is another one of the schematic diagrams about the first example according to an embodiment of the present disclosure;

FIG. 4 is still another one of the schematic diagrams about the first example according to an embodiment of the present disclosure;

FIG. 5 is another one of the flow charts about the communication method provided by an embodiment of the present disclosure;

FIG. 6 is one of the structural schematic diagrams about the electronic device provided by an embodiment of the present disclosure;

FIG. 7 is another one of the structural schematic diagrams about the electronic device provided by an embodiment of the present disclosure; and

FIG. 8 is still another one of the structural schematic diagrams about the electronic device provided by an embodiment of the present disclosure.

### DETAILED DESCRIPTION

In the embodiments of the present disclosure, the term “and/or” describes the association relationship among the associated objects, indicating that there may be three relationships. For example, A and/or B may represent: A exists alone, A and B exist at the same time, and B exists alone. The character “/” generally indicates that the objects associated before and after it are in an “or” relationship. In the embodiments of the present disclosure, the term “multiple” refers to two or more, and other quantifiers are similar.

Here, the example embodiments will be described in detail, and examples thereof are shown in the accompanying drawings. When the following description refers to the drawings, unless otherwise indicated, the same numbers in different drawings represent the same or similar elements. The embodiments described in the following example embodiments do not represent all the embodiments consistent with the present disclosure. Instead, they are merely examples of devices and methods consistent with some aspects of the present disclosure as detailed in the attached claims.

The terms used in the present disclosure are for the purpose of describing specific embodiments only and are not intended to limit the present disclosure. The singular forms “one”, “said”, and “the” used in the present disclosure and the attached claims are also intended to include the plural forms, unless the context clearly indicates other meanings. It should also be understood that the term “and/or” used herein refers to and includes any or all possible combinations of one or more associated items as listed.

It should be understood that although the terms first, second, third, etc. may be used in the present disclosure to describe various information, these information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the word “if” used herein may be interpreted as “at” or “when” or “in response to”.

The technical solutions in the embodiments of the present disclosure will be clearly and completely described below in conjunction with the drawings in the embodiments of the present disclosure. It shall be noted that the described embodiments are only part of the embodiments of the present disclosure, not all of them. Based on the embodiments in the present disclosure, all other embodiments obtained by those of ordinary skills in the art without creative work are within the protection scope of the present disclosure.

The embodiments of the present disclosure provide a communication method and apparatus, an electronic device, and a storage medium, so that a format of a radio frame is provided for sending a sensing measurement report.

The method and the apparatus are based on the same application concept. Since the principles for solving the problem by the method and the apparatus are similar, the implementation of the apparatus and the method may refer to each other, and the repetitions will not be repeated.

As shown in FIG. 1, the embodiments of the present disclosure provide a communication method, which may be performed by a sensing responder, and the method may include the following step 101.

Step 101, sending a target radio frame, where the target radio frame includes a Sensing Measurement Report information element, the Sensing Measurement Report information element includes a sensing measurement report control field, the sensing measurement report control field includes a subcarrier grouping subfield, and the grouping subfield indicates the number of subcarrier groups for channel sensing by the sensing initiator.

When the channel bandwidth of the Null Data Packet, NDP, is 160 MHz and the number of transmitting antennas of the sensing initiator is greater than or equal to 5, the value of the grouping subfield is 8.

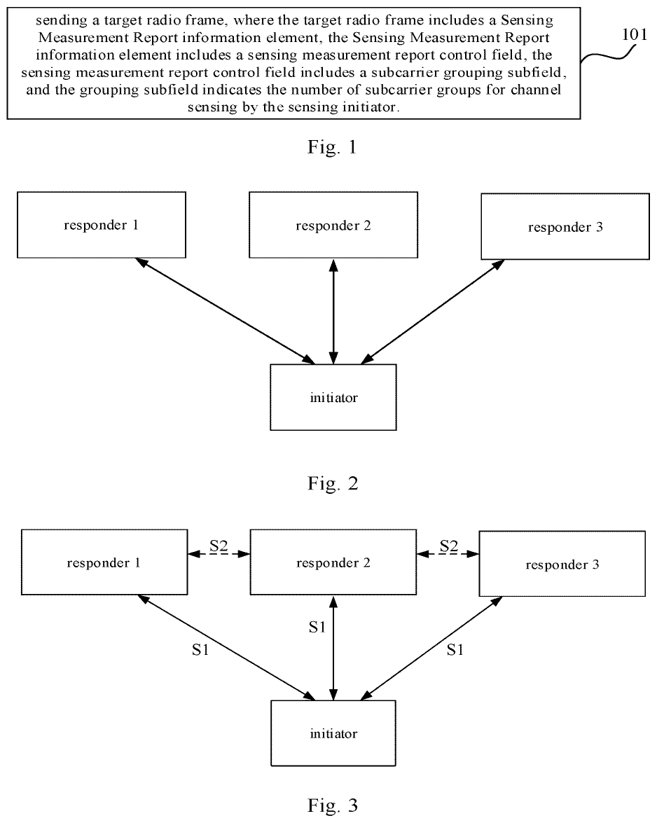

As a first example, referring to FIG. 2 to FIG. 4, the WLAN Sensing architecture and the WLAN Sensing process, to which the communication method provided by the embodiments of the present disclosure is applied, are firstly introduced.

FIG. 2 shows a schematic diagram of a WLAN Sensing architecture (process), where a sensing initiator (or initiator) initiates WLAN Sensing (for example, initiates a WLAN sensing session), and there may be multiple sensing responders (or sensing receivers) or responders responding to WLAN Sensing, such as responder 1, responder 2, and responder 3 as shown in FIG. 2. When the sensing initiator initiates WLAN Sensing, multiple associated or unassociated WLAN Sensing responders may respond.

Referring to FIG. 3, the sensing initiator communicates with the sensing responder through a communication connection, as shown by communication connection S1. The sensing responders communicate with each other through communication connection S2.

Each sensing initiator may be a client. Each sensing responder (in this example, sensing responder 1 to sensing responder 3) may be a station device (STA) or an access point device (AP). In addition, STA and AP may assume multiple roles in the WLAN sensing process. For example, in the WLAN sensing process, STA may also serve as a sensing initiator. The sensing initiator may be a sensing transmitter, a sensing receiver, or both, or neither. In the WLAN sensing process, the sensing responder may also be a sensing transmitter, a sensing receiver, or both.

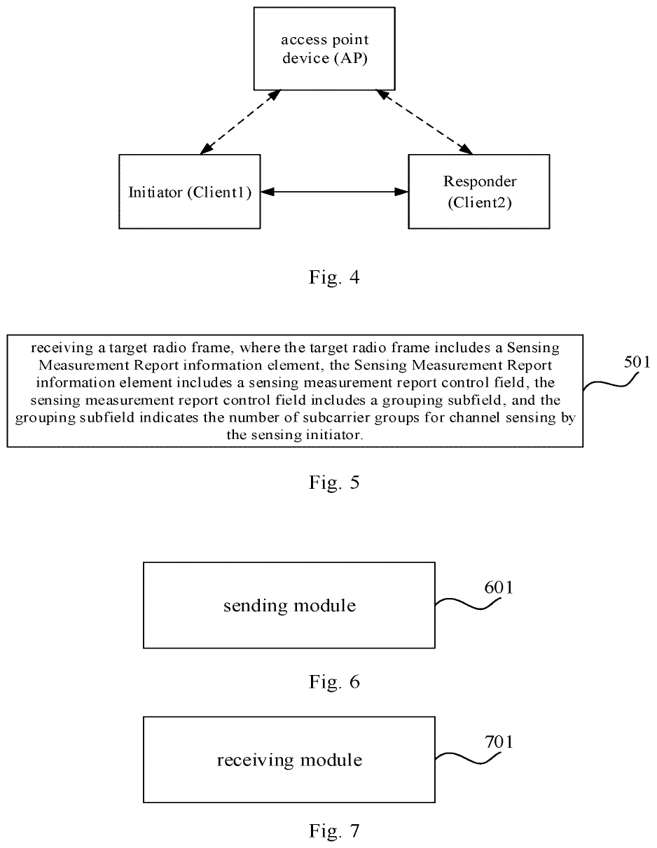

According to another architecture, as shown in FIG. 4, the sensing initiator and the sensing responder may also be clients, and the two may communicate by connecting to the same access point device (AP). In FIG. 4, Client1 is the sensing initiator, and Client2 is the sensing responder.

In the WLAN sensing measurement process, the sensing responder sends a target radio frame to the sensing initiator, where the target radio frame may be a sensing measurement report frame. As a third example, the format of the target radio frame is shown in Table 1 below:

TABLE 1

| | | | | Sensing |
|---|---|---|---|---|
| information | | Public | Dialog | Measurement |
| content | Category | action | Token/MSID | Report |
| Octets | 1 | 1 | 1 | variable |

The target radio frame carries a Sensing Measurement Report information element. As a fourth example, the format of the Sensing Measurement Report information element is shown in Table 2 below:

TABLE 2

| | | | | Sensing | Sensing | |
|---|---|---|---|---|---|---|
| | | | Element | Measurement | Measurement | Sensing |
| information | Element | | ID | Report | Report | Measurement |
| content | ID | Length | Extension | type | control | Report |
| Octets | 1 | 1 | 1 | TBD | TBD | variable |

As shown in Table 2 above, the Sensing Measurement Report information element includes a sensing measurement report control field and a sensing measurement report field, where the sensing measurement report control field includes field information required to identify the sensing measurement report field.

Specifically, the sensing measurement report control field includes a subcarrier grouping subfield, and the grouping subfield indicates the number of subcarrier groups for channel sensing by the sensing initiator. When the channel bandwidth of the Null Data Packet (NDP) is 160 MHz and the number of transmitting antennas of the sensing initiator is greater than or equal to 5, the value of the grouping subfield is 8. In other cases, for example, when the channel bandwidth of the NDP is not 160 MHz or the number of transmitting antennas of the sensing initiator is less than 5, the value of the grouping subfield may be 4 or 16. Specifically, several examples are listed as follows.

In Example 1, when the number of transmitting antennas of the sensing initiator is less than 4, the value of the grouping subfield may be 4 or 16.

In Example 2, when the number of transmitting antennas of the sensing initiator is greater than or equal to 5 and the channel bandwidth of the NDP is 80 MHz, the value of the grouping subfield may be 4 or 16.

In Example 3, when the number of transmitting antennas of the sensing initiator is greater than 5 and the channel bandwidth of the NDP is 80 MHz, it may be set to 16.

In an embodiment of the present disclosure, a sensing responder sends a target radio frame. The target radio frame includes a Sensing Measurement Report information element. The Sensing Measurement Report information element includes a sensing measurement report control field. The sensing measurement report control field includes a subcarrier grouping subfield. The grouping subfield indicates the number of subcarrier groups for channel sensing by the sensing initiator. An embodiment of the present disclosure provides a format of a radio frame for sending a sensing measurement report.

The embodiments of the present disclosure further provide a communication method, which may be performed by a sensing responder, and the method may include the following step: sending a target radio frame.

The target radio frame includes a Sensing Measurement Report information element. The Sensing Measurement Report information element includes a sensing measurement report control field. The sensing measurement report control field includes a subcarrier grouping subfield. The grouping subfield indicates the number of subcarrier groups for channel sensing by the sensing initiator.

When the channel bandwidth of the Null Data Packet, NDP, is 160 MHz and the number of transmitting antennas of the sensing initiator is greater than or equal to 5, the value of the grouping subfield is 8.

The sensing measurement report control field further includes a codebook information subfield.

The codebook information subfield includes a first identification bit, and the first identification bit indicates the bit length of the Channel State Information, CSI.

The codebook information subfield may be identified by one bit. For example, “0” is used to identify that the length of its CSI report is 8 bits, and “1” is used to identify that the length of the CSI report is 10 bits.

In some examples, if the value of the first identification bit is 8 or 10, the CSI includes an in-phase value and a quadrature value.

The 8 or 10 bits contain values of two lengths, in-phase and quadrature, respectively. For example, when it is 8 bits, 3 bits identify the in-phase value, and 5 bits identify the quadrature value.

The embodiments of the present disclosure further provide a communication method, which may be performed by a sensing responder, and the method may include the following step: sending a target radio frame.

The target radio frame includes a Sensing Measurement Report information element. The Sensing Measurement Report information element includes a sensing measurement report control field. The sensing measurement report control field includes a subcarrier grouping subfield. The grouping subfield indicates the number of subcarrier groups for channel sensing by the sensing initiator.

When the channel bandwidth of the Null Data Packet, NDP, is 160 MHz and the number of transmitting antennas of the sensing initiator is greater than or equal to 5, the value of the grouping subfield is 8.

The sensing measurement report control field also includes a Resource Unit allocation (RU allocation) information subfield.

The RU allocation information subfield includes: an RU start index identification bit, an RU end index identification bit, and a spatial flow information identification bit. The RU start index identification bit identifies the RU start position for sensing measurement. The RU end index identification bit identifies the RU end position for sensing measurement. The RU start index identification bit and the RU end index identification bit are related to the bandwidth BW, and different BWs support different numbers of RUs. The spatial flow information identification bit identifies the spatial flow corresponding to the Sensing Measurement Report information element.

The embodiments of the present disclosure further provide a communication method, which may be performed by a sensing responder, and the method may include the following step: sending a target radio frame.

The target radio frame includes a Sensing Measurement Report information element. The Sensing Measurement Report information element includes a sensing measurement report control field. The sensing measurement report control field includes a subcarrier grouping subfield. The grouping subfield indicates the number of subcarrier groups for channel sensing by the sensing initiator.

When the channel bandwidth of the Null Data Packet, NDP, is 160 MHz and the number of transmitting antennas of the sensing initiator is greater than or equal to 5, the value of the grouping subfield is 8.

The sensing measurement report control field may include a sensing Dialogue Token subfield. The sensing Dialog Token subfield includes a sensing Measurement Setup ID (MSID), which identifies the sensing measurement event corresponding to the Sensing Measurement Report information element.

The embodiments of the present disclosure further provide a communication method, which may be performed by a sensing responder, and the method may include the following step: sending a target radio frame.

The target radio frame includes a Sensing Measurement Report information element. The Sensing Measurement Report information element includes a sensing measurement report control field. The sensing measurement report control field includes a subcarrier grouping subfield. The grouping subfield indicates the number of subcarrier groups for channel sensing by the sensing initiator.

When the channel bandwidth of the Null Data Packet, NDP, is 160 MHz and the number of transmitting antennas of the sensing initiator is greater than or equal to 5, the value of the grouping subfield is 8. The target radio frame includes a Sensing Measurement Report frame.

The Sensing Measurement Report frame includes one or more Sensing Measurement Report information elements. That is, the Sensing Measurement Report frame may include one or more Sensing Measurement Report information elements.

The Sensing Measurement Report frame includes a Dialog Token field. The value of the Dialog Token field is the same as the Dialog Token value of the measurement setup request frame and the Dialog Token value of the measurement setup response frame to identify the same dialog information.

In the embodiments of the present disclosure, the sensing responder sends a target radio frame. The target radio frame includes a Sensing Measurement Report information element. The Sensing Measurement Report information element includes a sensing measurement report control field. The sensing measurement report control field includes a subcarrier grouping subfield. The grouping subfield indicates the number of subcarrier groups for channel sensing by the sensing initiator.

As shown in FIG. 5, the embodiments of the present disclosure provide a communication method, which may be performed by the sensing initiator, and the method may include the following step 501.

Step 501, receiving a target radio frame, where the target radio frame includes a Sensing Measurement Report information element, the Sensing Measurement Report information element includes a sensing measurement report control field, the sensing measurement report control field includes a grouping subfield, and the grouping subfield indicates the number of subcarrier groups for channel sensing by the sensing initiator.

When the channel bandwidth of the Null Data Packet, NDP, is 160 MHz and the number of transmitting antennas of the sensing initiator is greater than or equal to 5, the value of the grouping subfield is 8.

The WLAN Sensing architecture and the WLAN Sensing process, to which the communication method provided in the embodiments of the present disclosure is applied, may refer to the aforementioned first example, which will not be repeated here.

In the WLAN sensing measurement process, the sensing initiator receives the target radio frame sent by the sensing responder, and the target radio frame may be a sensing measurement report frame. As a third example, the format of the target radio frame is shown in Table 1 below:

TABLE 1

| | | | | Sensing |
|---|---|---|---|---|
| information | | Public | Dialog | Measurement |
| content | Category | action | Token/MSID | Report |
| Octets | 1 | 1 | 1 | variable |

The target radio frame carries a Sensing Measurement Report information element. As a fourth example, the format of the Sensing Measurement Report information element is shown in Table 2 below:

TABLE 2

| | | | | Sensing | Sensing | |
|---|---|---|---|---|---|---|
| | | | Element | Measurement | Measurement | Sensing |
| information | Element | | ID | Report | Report | Measurement |
| content | ID | Length | Extension | type | control | Report |
| Octets | 1 | 1 | 1 | TBD | TBD | variable |

As shown in Table 2 above, the Sensing Measurement Report information element includes a sensing measurement report control field and a sensing measurement report field. The sensing measurement report control field includes field information required to identify the sensing measurement report field.

Specifically, the sensing measurement report control field includes a subcarrier grouping subfield, and the grouping subfield indicates the number of subcarrier groups for channel sensing by the sensing initiator. When the channel bandwidth of the Null Data Packet (NDP) is 160 megahertz (MHz) and the number of transmitting antennas of the sensing initiator is greater than or equal to 5, the value of the grouping subfield is 8. In other cases, for example, when the channel bandwidth of the NDP is not 160 megahertz (MHz) or the number of transmitting antennas of the sensing initiator is less than 5, the value of the grouping subfield may be 4 or 16.

In an example embodiment, the sensing measurement report control field also includes a codebook information subfield.

The codebook information subfield includes a first identification bit, and the first identification bit indicates the bit length of the Channel State Information, CSI.

In an example embodiment, if the value of the first identification bit is 8 or 10, the CSI includes an in-phase value and an orthogonal value.

In an example embodiment, the sensing measurement report control field also includes a Resource Unit allocation (RU allocation) information subfield.

The RU allocation information subfield includes: a RU start index identification bit, a RU end index identification bit, and a spatial flow information identification bit.

In an example embodiment, the sensing measurement report control field also includes a sensing Dialog Token subfield.

The sensing Dialog Token subfield includes a sensing measurement setup ID, MSID.

In an example embodiment, the target radio frame includes a Sensing Measurement Report frame.

The Sensing Measurement Report frame includes one or more Sensing Measurement Report information elements.

The Sensing Measurement Report frame includes a Dialog Token field, and the value of the Dialog Token field is the same as the Dialog Token value of the measurement setup request frame and the Dialog Token value of the measurement setup response frame.

In an example embodiment, the value of the grouping subfield includes 4 or 16.

In an embodiment of the present disclosure, a sensing initiator receives a target radio frame. The target radio frame includes a Sensing Measurement Report information element. The Sensing Measurement Report information element includes a sensing measurement report control field. The sensing measurement report control field includes a subcarrier grouping subfield. The grouping subfield indicates the number of subcarrier groups for channel sensing by the sensing initiator. The embodiments of the present disclosure provide a format of a radio frame for sending a sensing measurement report.

Referring to FIG. 6, based on the same principle as the method provided by the embodiments of the present disclosure, the embodiments of the present disclosure further provide an electronic device. The electronic device is a sensing responder, and the electronic device includes: a sending module 601, used for sending a target radio frame.

The target radio frame includes a Sensing Measurement Report information element. The Sensing Measurement Report information element includes a sensing measurement report control field. The sensing measurement report control field includes a subcarrier grouping subfield. The grouping subfield indicates the number of subcarrier groups for channel sensing by the sensing initiator.

When the channel bandwidth of the Null Data Packet, NDP, is 160 MHz and the number of transmitting antennas of the sensing initiator is greater than or equal to 5, the value of the grouping subfield is 8.

In an example embodiment, the sensing measurement report control field also includes a codebook information subfield.

The codebook information subfield includes a first identification bit, and the first identification bit indicates the bit length of the Channel State Information, CSI.

In an example embodiment, if the value of the first identification bit is 8 or 10, the CSI includes an in-phase value and an orthogonal value.

In an example embodiment, the sensing measurement report control field also includes a Resource Unit allocation (RU allocation) information subfield.

The RU allocation information subfield includes: RU start index identification bit, RU end index identification bit, and spatial flow information identification bit.

In an example embodiment, the sensing measurement report control field also includes a sensing Dialog Token subfield.

The sensing Dialog Token subfield includes a sensing measurement setup ID, MSID.

In an example embodiment, the target radio frame includes a Sensing Measurement Report frame.

The Sensing Measurement Report frame includes one or more Sensing Measurement Report information elements.

The Sensing Measurement Report frame includes a Dialog Token field, and the value of the Dialog Token field is the same as the Dialog Token value of the measurement setup request frame and the Dialog Token value of the measurement setup response frame.

In an example embodiment, the value of the grouping subfield includes 4 or 16.

In the embodiments of the present disclosure, the sending module 601 sends a target radio frame, where the target radio frame includes a Sensing Measurement Report information element, the Sensing Measurement Report information element includes a sensing measurement report control field, the sensing measurement report control field includes a subcarrier grouping subfield, and the grouping subfield indicates the number of subcarrier groups for channel sensing by the sensing initiator.

The embodiments of the present disclosure also provide a communication apparatus, which is performed by a sensing responder, and the apparatus includes: a radio frame sending module, used for sending a target radio frame.

The target radio frame includes a Sensing Measurement Report information element. The Sensing Measurement Report information element includes a sensing measurement report control field. The sensing measurement report control field includes a subcarrier grouping subfield. The grouping subfield indicates the number of subcarrier groups for channel sensing by the sensing initiator.

When the channel bandwidth of the Null Data Packet, NDP, is 160 MHz and the number of transmitting antennas of the sensing initiator is greater than or equal to 5, the value of the grouping subfield is 8.

The apparatus also includes other modules of the electronic device in the aforementioned embodiment(s), which will not be repeated here.

Referring to FIG. 7, based on the same principle as the method provided in the embodiments of the present disclosure, the embodiments of the present disclosure further provides an electronic device. The electronic device is a sensing responder, and the electronic device includes: a receiving module 701, used for receiving a target radio frame.

The target radio frame includes a Sensing Measurement Report information element. The Sensing Measurement Report information element includes a sensing measurement report control field. The sensing measurement report control field includes a grouping subfield. The grouping subfield indicates the number of subcarrier groups for channel sensing by the sensing initiator.

When the channel bandwidth of the Null Data Packet, NDP, is 160 MHz and the number of transmitting antennas of the sensing initiator is greater than or equal to 5, the value of the grouping subfield is 8.

In the embodiments of the present disclosure, the receiving module 701 receives a target radio frame, where the target radio frame includes a Sensing Measurement Report information element, the Sensing Measurement Report information element includes a sensing measurement report control field, the sensing measurement report control field includes a subcarrier grouping subfield, and the grouping subfield indicates the number of subcarrier groups for channel sensing by the sensing initiator.

The embodiments of the present disclosure further provide a communication apparatus, which is performed by a sensing responder, and the apparatus includes: a radio frame receiving module, used for receiving a target radio frame.

The target radio frame includes a Sensing Measurement Report information element. The Sensing Measurement Report information element includes a sensing measurement report control field. The sensing measurement report control field includes a grouping subfield. The grouping subfield indicates the number of subcarrier groups for channel sensing by the sensing initiator.

When the channel bandwidth of the Null Data Packet, NDP, is 160 MHz and the number of transmitting antennas of the sensing initiator is greater than or equal to 5, the value of the grouping subfield is 8.

The apparatus also includes other modules of the electronic device in the above-mentioned embodiment(s), which will not be repeated here.

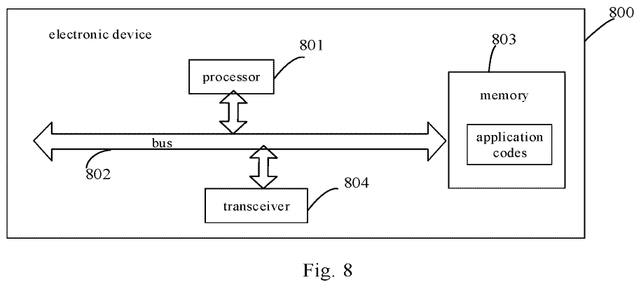

In an example embodiment, the embodiment of the present disclosure also provides an electronic device, as shown in FIG. 8. The electronic device 800 shown in FIG. 8 may be a server, including: a processor 801 and a memory 803. The processor 801 and the memory 803 are connected, such as through a bus 802. For example, the electronic device 800 may also include a transceiver 804. It should be noted that in actual applications, the number of transceivers 804 is not limited to one, and the structure of the electronic device 800 does not constitute any limitation on the embodiments of the present disclosure.

The processor 801 may be a Central Processing Unit (CPU), a general-purpose processor, a Digital Signal Processor (DSP), an Application Specific Integrated Circuit (ASIC), a Field Programmable Gate Array (FPGA), or other programmable logic devices, transistor logic devices, hardware components, or any combination thereof. It may implement or execute various example logic blocks, modules, and circuits described in conjunction with the present disclosure. The processor 801 may also be a combination that implements computing functions, such as a combination of one or more microprocessors, a combination of DSP and microprocessors, etc.

The bus 802 may include a path to transmit information between the above components. The bus 802 may be a Peripheral Component Interconnect (PCI) bus or an Extended Industry Standard Architecture (EISA) bus, etc. The bus 802 may be divided into an address bus, a data bus, a control bus, etc. For the ease of representation, only one thick line is used in FIG. 8, but this does not mean that there is only one bus or one type of bus.

The memory 803 may be a Read Only Memory (ROM) or other types of static storage devices that can store static information and instructions, a Random Access Memory (RAM), or other types of dynamic storage devices that can store information and instructions, or may be an Electrically Erasable Programmable Read Only Memory (EEPROM), a Compact Disc-Read Only Memory (CD-ROM), or other optical disc storage, optical disk storage (including compressed optical disk, laser disk, optical disk, digital versatile disk, Blu-ray disk, etc.), a disk storage medium, or other magnetic storage device, or any other medium that can be used to carry or store the desired program code in the form of instructions or data structures and can be accessed by a computer, but is not limited thereto.

The memory 803 is used to store the application codes for executing the disclosed solution(s), and is controlled by the processor 801 to execute. The processor 801 is used to execute the application codes stored in the memory 803 to implement the contents shown in the aforementioned method embodiments.

The electronic devices include but are not limited to: mobile phones, laptops, digital broadcast receivers, personal digital assistants (PDAs), tablet computers (PADs), portable multimedia players (PMPs), vehicle-mounted terminals (such as vehicle-mounted navigation terminals), etc., and fixed terminals such as digital TVs, desktop computers, etc. The electronic device shown in FIG. 8 is only an example and should not impose any restriction on the functions and use scope of the embodiments of the present disclosure.

The server provided in the present disclosure may be an independent physical server, or a server cluster or distributed system composed of multiple physical servers, or may be a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal may be a smart phone, a tablet computer, a laptop computer, a desktop computer, a smart speaker, a smart watch, etc., but is not limited thereto. The terminal and the server may be directly or indirectly connected via wired or wireless communication, which is not limited in the present disclosure.

The embodiments of the present disclosure provide a computer-readable storage medium, on which a computer program is stored. When the computer program is run on a computer, the computer can perform the corresponding contents in the aforementioned method embodiments.

It should be understood that, although the steps in the flowchart of the accompanying drawings are displayed in sequence as indicated by the arrows, these steps are not necessarily executed in the order indicated by the arrows. Unless otherwise specified herein, the execution of these steps is not strictly limited in order, and they may be executed in other orders. Moreover, at least some of the steps in the flowchart of the accompanying drawings may include multiple sub-steps or multiple stages. These sub-steps or stages are not necessarily executed at the same time, but may be executed at different times, and their execution order is not necessarily sequential, but may be executed in turn or alternately with other steps or at least some of the sub-steps or stages of other steps.

It should be noted that the above-mentioned computer-readable medium of the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus, or device, or any combination of the above. More specific examples of computer-readable storage media may include, but are not limited to, an electrical connection with one or more conductors, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that can be used by or in conjunction with an instruction execution system, apparatus, or device. In the present disclosure, the computer-readable signal medium may include a data signal propagated in a baseband or as part of a carrier wave, in which a computer-readable program code is carried. Such propagated data signals may take a variety of forms, including but not limited to electromagnetic signals, optical signals, or any suitable combination of the above. The computer-readable signal medium may also be any computer-readable medium other than a computer-readable storage medium, which may send, propagate, or transmit a program for use by or in conjunction with an instruction execution system, apparatus, or device. The program code contained on the computer-readable medium may be transmitted by any appropriate medium, including but not limited to: wires, optical cables, radio frequency (RF), etc., or any suitable combination of the above.

The above-mentioned computer-readable medium may be contained in the above-mentioned electronic device; or may exist separately without being assembled into the electronic device.

The above-mentioned computer-readable medium carries one or more programs. When the above-mentioned one or more programs are executed by the electronic device, the electronic device is caused to perform the method shown in the above-mentioned embodiment(s).

According to an aspect of the present disclosure, a computer program product or computer program is provided. The computer program product or computer program includes computer instructions, and the computer instructions are stored in a computer-readable storage medium. The processor of the computer device reads the computer instructions from the computer-readable storage medium, and the processor executes the computer instructions, so that the computer device performs the method provided in the above-mentioned various example implementations.

The computer program codes for performing the operations of the present disclosure may be written in one or more programming languages or a combination thereof. The above-mentioned programming languages include object-oriented programming languages such as Java, Smalltalk, C++, and also conventional procedural programming languages such as “C” language or similar programming languages. The program codes may be executed entirely on the user's computer, partially on the user's computer, as a separate software package, partially on the user's computer and partially on a remote computer, or entirely on a remote computer or server. With a remote computer involved, the remote computer may be connected to the user's computer through any type of network, including a Local Area Network (LAN) or a Wide Area Network (WAN), or may be connected to an external computer (e.g., through the Internet using an Internet service provider).

The flowcharts and block diagrams in the accompanying drawings illustrate the possible implementation architecture, functions, and operations of the systems, methods, and computer program products according to various embodiments of the present disclosure. In this regard, each box in the flowchart or block diagram may represent a module, a program segment, or a portion of codes, which contains one or more executable instructions for implementing a specified logical function. It should also be noted that in some alternative implementations, the functions marked in the box may also occur in an order different from that marked in the accompanying drawings. For example, two boxes represented in succession may actually be executed substantially in parallel, and they may sometimes be executed in a reverse order, depending on the functions involved. It should also be noted that each box in the block diagram and/or flowchart, and the combination of boxes in the block diagram and/or flowchart, may be implemented by a dedicated hardware-based system that performs the specified function or operation, or may be implemented by a combination of dedicated hardware and computer instructions.

The modules involved in the embodiments described by the present disclosure may be implemented by software or by hardware. The name of the module does not constitute any limitation on the module itself in some cases. For example, module A may also be described as “module A for performing operation B”.

The above description is only an example embodiment of the present disclosure and an explanation of the technical principles used. Those skilled in the art should understand that the scope of the present disclosure is not limited to the technical solutions formed by a specific combination of the above technical features, but also should cover other technical solutions formed by any combination of the above technical features or their equivalent features without departing from the above disclosure concept. For example, the above features may be replaced by the technical features with similar functions disclosed in the present disclosure (but not limited to).

1. A communication method, performed by a sensing responder, and comprising:
sending a target radio frame, wherein
the target radio frame comprises a Sensing Measurement Report information element, the Sensing Measurement Report information element comprises a sensing measurement report control field, the sensing measurement report control field comprises a subcarrier grouping subfield, and the grouping subfield indicates a number of subcarrier groups for channel sensing by a sensing initiator; and
a channel bandwidth of a Null Data Packet (NDP) is 160 MHz and a number of transmitting antennas of the sensing initiator is greater than or equal to 5, a value of the grouping subfield is 8.

2. The communication method according to claim 1, wherein
the sensing measurement report control field further comprises a codebook information subfield; and
the codebook information subfield comprises a first identification bit, the first identification bit indicating a bit length of Channel State Information (CSI).

3. The communication method according to claim 2, wherein in a case that a value of the first identification bit is 8 or 10, the CSI comprises an in-phase value and a quadrature value.

4. The communication method according to claim 1, wherein
the sensing measurement report control field further comprises a Resource Unit (RU) allocation information subfield; and
the RU allocation information subfield comprises: a RU start index identification bit, a RU end index identification bit, and a spatial flow information identification bit.

5. The communication method according to claim 1, wherein
the sensing measurement report control field further comprises a sensing Dialog Token subfield; and
the sensing Dialog Token subfield comprises a sensing Measurement Setup ID (MSID).

6. The communication method according to claim 1, wherein
the target radio frame is a Sensing Measurement Report frame; and
the Sensing Measurement Report frame comprises a Dialog Token field, a value of the Dialog Token field being the same as a Dialog Token value of a measurement setup request frame and a Dialog Token value of a measurement setup response frame.

7. The communication method according to claim 1, wherein a value of the grouping subfield comprises 4 or 16.

8. A communication method, performed by a sensing initiator, and comprising:
receiving a target radio frame, wherein
the target radio frame comprises a Sensing Measurement Report information element, the Sensing Measurement Report information element comprises a sensing measurement report control field, the sensing measurement report control field comprises a grouping subfield, and the grouping subfield indicates a number of subcarrier groups for channel sensing by the sensing initiator; and
a channel bandwidth of a Null Data Packet (NDP) is 160 MHz and a number of transmitting antennas of the sensing initiator is greater than or equal to 5, a value of the grouping subfield is 8.

9. (canceled)

10. (canceled)

11. An electronic device, comprising a memory, a processor, and a computer program stored in the memory and executable on the processor, wherein the processor implements a communication method, comprising:
sending a target radio frame, wherein
the target radio frame comprises a Sensing Measurement Report information element, the Sensing Measurement Report information element comprises a sensing measurement report control field, the sensing measurement report control field comprises a subcarrier grouping subfield, and the grouping subfield indicates a number of subcarrier groups for channel sensing by a sensing initiator; and
a channel bandwidth of a Null Data Packet (NDP) is 160 MHz and a number of transmitting antennas of the sensing initiator is greater than or equal to 5, a value of the grouping subfield is 8.

12. (canceled)

13. An electronic device, comprising a memory, a processor, and a computer program stored in the memory and executable on the processor, wherein the processor implements the method according to claim 8.

14. The communication method according to claim 8, wherein
the sensing measurement report control field further comprises a codebook information subfield; and
the codebook information subfield comprises a first identification bit, the first identification bit indicating a bit length of Channel State Information (CSI).

15. The communication method according to claim 14, wherein in a case that a value of the first identification bit is 8 or 10, the CSI comprises an in-phase value and a quadrature value.

16. The communication method according to claim 8, wherein
the sensing measurement report control field further comprises a Resource Unit (RU) allocation information subfield; and
the RU allocation information subfield comprises: a RU start index identification bit, a RU end index identification bit, and a spatial flow information identification bit.

17. The communication method according to claim 8, wherein
the sensing measurement report control field further comprises a sensing Dialog Token subfield; and
the sensing Dialog Token subfield comprises a sensing Measurement Setup ID (MSID).

18. The communication method according to claim 8, wherein
the target radio frame is a Sensing Measurement Report frame; and
the Sensing Measurement Report frame comprises a Dialog Token field, a value of the Dialog Token field being the same as a Dialog Token value of a measurement setup request frame and a Dialog Token value of a measurement setup response frame.

19. The communication method according to claim 8, wherein a value of the grouping subfield comprises 4 or 16.

20. The electronic device according to claim 11, wherein
the sensing measurement report control field further comprises a codebook information subfield; and
the codebook information subfield comprises a first identification bit, the first identification bit indicating a bit length of Channel State Information (CSI).

21. The electronic device according to claim 20, wherein if a value of the first identification bit is 8 or 10, the CSI comprises an in-phase value and a quadrature value.

22. The electronic device according to claim 11, wherein
the sensing measurement report control field further comprises a Resource Unit (RU) allocation information subfield; and
the RU allocation information subfield comprises: a RU start index identification bit, a RU end index identification bit, and a spatial flow information identification bit.

23. The electronic device according to claim 11, wherein
the sensing measurement report control field further comprises a sensing Dialog Token subfield; and
the sensing Dialog Token subfield comprises a sensing Measurement Setup ID (MSID).
